(19) United States
(12) Patent Application Publication
(10) Pub. No.: US 2018/0330447 A1
(43) Pub. Date: Nov. 15, 2018

(54) MODELING ASSET PRICES FROM HISTORICAL DATA

(71) Applicant: CHRISTOPHER SEAN SLOTTERBACK, STAATSBURG, NY (US)

(72) Inventor: CHRISTOPHER SEAN SLOTTERBACK, STAATSBURG, NY (US)

(21) Appl. No.: 15/979,681

(22) Filed: May 15, 2018

Related U.S. Application Data
(60) Provisional application No. 62/506,123, filed on May 15, 2017.

(51) Int. Cl. G06Q 40/06; G06Q 10/06; G06Q 10/04

(52) U.S. Cl. CPC G06Q 40/06; G06Q 10/04; G06Q 10/067

(57) ABSTRACT

Systems and methods are provided for projecting the performance of a portfolio drawn from an available plurality of assets. A plurality of time series of values for the plurality of assets are sampled over a defined period. The plurality of times series of values are concatenated, at a corresponding plurality of points of concatenation, to provide a synthetic time series. A volatility model is applied at each of the plurality of points of concatenation, such that a first set of values of the synthetic time series that follow the point of concatenation are altered at least in part according to a correlation matrix generated from a second set of values of the synthetic time series that precede the point of concatenation. The performance of the portfolio is simulated from the synthetic time series to provide a projected value of the portfolio at a selected goal horizon.

### RELATED APPLICATIONS

The present application claims priority to U.S. Provisional Patent Application Ser. No. 62/506,123 filed May 15, 2017 entitled MODELING ASSET PRICES FROM HISTORICAL DATA under Attorney Docket Number SEAN-026597 US PRO, the entire contents of which being incorporated herein by reference in its entirety for all purposes.

### TECHNICAL FIELD

The present invention relates generally to economic forecasting, and more particularly to modeling asset prices from historical data.

### BACKGROUND

Many institutions engage in economic forecasting, including international organizations such as the International Monetary Fund, World Bank and the OECD, national governments and central banks, and private sector entities, including think-tanks, banks, consultants and companies. Economists may use statistical analysis of historical data to determine the apparent relationships between particular independent variables and their relationship to the dependent variable under study, and this relationship can then be used to forecast the future. Forecasts are generally based on sample data rather than a complete population, which introduces uncertainty. The economist conducts statistical tests and develops statistical models to determine which relationships best describe or predict the behavior of the variables under study. Historical data and assumptions about the future are applied to the model in arriving at a forecast for particular variables.

### SUMMARY

In one example, a method is provided for projecting the performance of a portfolio drawn from an available plurality of assets. A plurality of time series of values for the plurality of assets are sampled over a defined period. The plurality of times series of values are concatenated, at a corresponding plurality of points of concatenation, to provide a synthetic time series. A volatility model is applied at each of the plurality of points of concatenation, such that a first set of values of the synthetic time series that follow the point of concatenation are altered at least in part according to a correlation matrix generated from a second set of values of the synthetic time series that precede the point of concatenation. The performance of the portfolio is simulated from the synthetic time series to provide a projected value of the portfolio at a selected goal horizon.

In another example, a system includes a processor and a non-transitory computer readable medium that stores instructions executable by the processor for projecting the performance of a portfolio drawn from an available plurality of assets. The executable instructions include a database comprising values for the plurality of assets over a defined period and a time series generator that samples a plurality of time series of values for the plurality of assets from the database and concatenates the plurality of times series of values, at a corresponding plurality of points of concatenation, to provide a synthetic time series. A portfolio evaluator simulates the performance of the portfolio from the synthetic time series to provide a projected value of the portfolio at a selected goal horizon by evaluating the portfolio over a predetermined number of days, rebalancing the portfolio according to a predetermined investment strategy when a predetermined condition is met, and applies a behavior model to the portfolio, representing a reaction of an investor to changes in the market that deviate from the predetermined investment strategy.

In yet a further example, a method is provided for projecting the performance of a portfolio drawn from an available plurality of assets. A plurality of time series of values for the plurality of assets are sampled over a defined period. The plurality of times series of values are concatenated, at a corresponding plurality of points of concatenation, to provide a synthetic time series. A volatility model is applied at each of the plurality of points of concatenation, such that a first set of values of the synthetic time series that follow the point of concatenation are altered at least in part according to a correlation matrix generated from a second set of values of the synthetic time series that precede the point of concatenation. The performance of the portfolio is simulated from the synthetic time series to provide a projected value of the portfolio at a selected goal horizon by evaluating the portfolio over a predetermined number of days, rebalancing the portfolio according to a predetermined investment strategy when a predetermined condition is met, and applying a behavior model to the portfolio, representing a reaction of an investor to changes in the market that deviate from the predetermined investment strategy.

### BRIEF DESCRIPTION OF THE DRAWINGS

FIG. 1 illustrates a system for projecting the performance of a portfolio drawn from an available plurality of assets;

FIG. 2 illustrates one example of a method for projecting the performance of a portfolio drawn from an available plurality of assets;

FIG. 3 illustrates one example of a method for generating a synthetic time series of prices for a defined universe of assets;

FIG. 4 illustrates one example of a method for applying a volatility model to a point of concatenation between two time series;

FIG. 5 illustrates a method for evaluating a portfolio over a selected forecast period with a synthetic price history, such as that generated in FIG. 3;

FIG. 6 illustrates one example of a method for modeling investor behavior;

FIG. 7 illustrates one example of a method for determining an optimal portfolio; and

FIG. 8 is a schematic block diagram illustrating an exemplary system 800 of hardware components capable of implementing examples of the systems and methods disclosed in FIGS. 1-7.

### DETAILED DESCRIPTION

One of the primary goals of investing is to attain the highest rate of return R for a given tolerance to risk, specified as some parameter O. This goal is frustrated by the fact that the investor does not know the risk or real return on any security a priori and must invest based on the expected return E(R). Or, as investment professionals often caution: “Historical returns are not a guarantee of future performance.” One can easily pick a set of investments or investment rules that have incredible success in hindsight yet perform poorly in the future. This is called overfitting, and it is the bugbear of trading strategies. The problem lies in discerning the hidden processes that will continue into the future and separating them from both random noise and those processes that have ceased to exist. There is a great deal of research dedicated to techniques that can reduce overfitting. Successful techniques include regularization and cross validation.

Perhaps the most obvious way of evaluating an investment is to ask how it, or a similar investment, has performed in the past. Historical data, however, is limited and while certain stocks and commodities have data going back over a century, other asset classes (e.g., REITs, convertibles, various bonds, etc.) may only have a few years of reliable data. Even for asset classes with longer histories, evolutions in markets make the earlier data less relevant in the present. In determining contemporaneous relationships between asset returns, for example, in estimating a covariance matrix, then it is necessary to rely on more recent time periods during which all the relevant assets have traded. If the same historical period is used both to discover and validate the same trading strategy, overfitting is likely, resulting poor future performance. It is necessary to cross-validate, testing the strategy on data as held away from the research process as possible.

For shorter-term traders with holding periods from sub-second to several days this is not an insurmountable problem. Given their short holding period, they can observe many more data points. For example, if it is a strategy that attempts to profit over one-minute intervals, the investor has hundreds of data points per day to observe. And fresh data, the only true out-of-sample test, is constantly being generated. Longer term investors are not so lucky. A person with a thirty or forty year horizon typical for a retirement account arguably has only a handful of relevant data points with which to work. While short term traders make up a relatively small part of the overall market, they are mostly professionals who, one would expect, understand the risks in their business model. Longer term investors are comprised largely of non-professionals who are investing in order to retire, pay for college, pay for health care or long-term care, or similar goals. An error in their investing assumptions can have drastic implications on their lives if they, for instance, have not saved enough to support themselves at retirement. Accordingly, the systems and methods described herein provide a way of estimating future performance over long time horizons in a way that is accessible to the typical investor and that accurately models how their investments will grow over time.

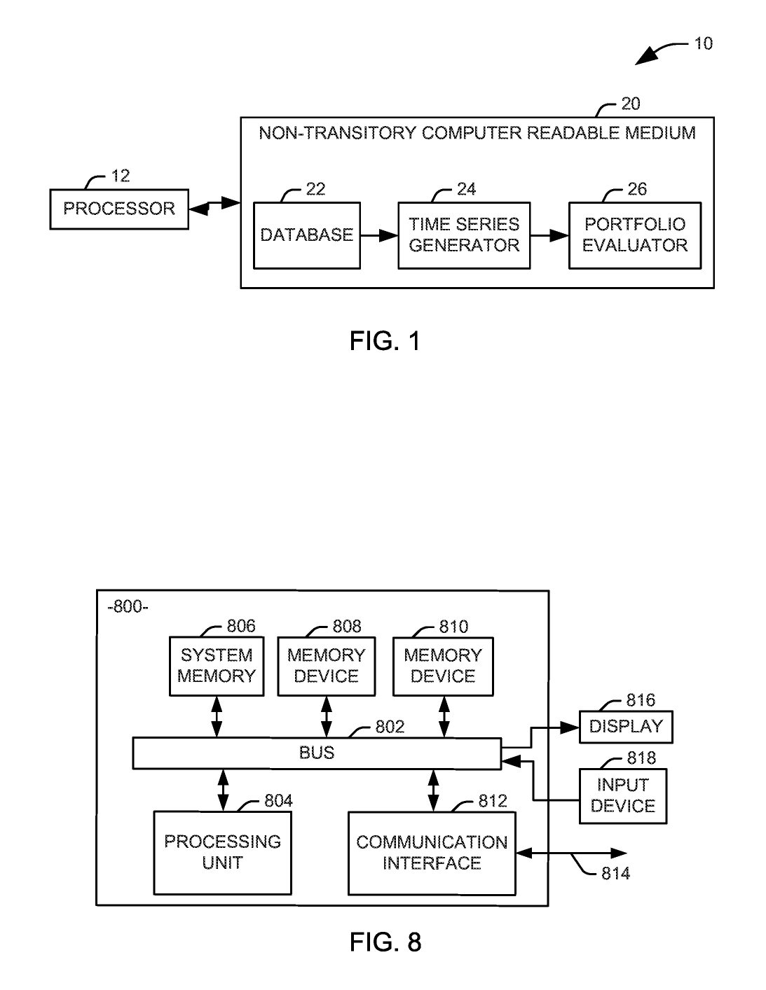

FIG. 1 illustrates a system 10 for projecting the performance of a portfolio drawn from an available plurality of assets. The system includes a processor 12 and a non-transitory computer readable medium 20 storing instructions executable by the processor for projecting the performance of a portfolio drawn from an available plurality of assets. The non-transitory computer readable medium 20 stores a database 22 that includes values for the plurality of assets over a defined period. Where values are unavailable for a given asset during the define period, entries for the asset can be generated via a single factor model to provide data for any assets for which data is unavailable.

The computer readable medium 20 also stores a time series generator 22 that samples a plurality of time series of values for the plurality of assets from the database and concatenating the plurality of times series of values, at a corresponding plurality of points of concatenation, to provide a synthetic time series. The plurality of time series can be sampled, for example, by randomly selecting a starting point for each time series from a uniform distribution and randomly selecting a length for each time series from a lognormal distribution.

In one implementation, a volatility model is applied at each of the plurality of points of concatenation to eliminate discontinuities in the variance of the data sets. In one example, the volatility model is applied to alter a first set of values of the synthetic time series that follow the point of concatenation, referred to as the prediction horizon, according to a correlation matrix generated from a second set of values of the synthetic time series that precede the point of concatenation, referred to as the look-back window.

In one implementation of the volatility model, a merged correlation matrix is formed as a weighted linear combination of the correlation matrix generated from the look-back window and a correlation matrix generated from the prediction horizon. An autoregressive conditional heteroskedasticity model, such as a Glosten-Jagannathan-Runkle generalized autoregressive conditional heteroskedasticity model, can be applied to a set of data preceding the point of concatenation for each of the plurality of assets to provide an projected standard deviation for each of the plurality of assets. A covariance matrix can then be generated with each element of the covariance matrix being the product of the projected standard deviation of the asset associated with the column of the element, the projected standard deviation of the asset associated with the row of the element, and the corresponding element from the third correlation matrix.

New values for the first set of values can be determined from the generated covariance matrix. In one example, the first set of values are altered to a value that is a function of each of a set of mean values for each security across the set of time periods, the values in the look-back window, a square root of the covariance matrix, and a unique inverse matrix square root of a second covariance matrix representing the look-back window. In practice, each of the size of the prediction horizon, the size of the look-back window, and at least one weight for the weighted linear combination are determined via an optimization process that minimizes a difference between a volatility-clustering factor for the synthetic data series and a historical volatility-clustering factor for the plurality of assets

A portfolio evaluator 26 simulates the performance of the portfolio from the synthetic time series by evaluating the portfolio over a predetermined number of days, rebalancing the portfolio according to a predetermined investment strategy when a predetermined condition is met, and applies a behavior model to the portfolio, representing a reaction of an investor to changes in the market that deviate from the predetermined investment strategy. In one example, the performance of the portfolio is simulated over a predetermined number of days from the synthetic time series, with the portfolio rebalanced according to a predetermined investment strategy when a predetermined condition is met. This can include a behavior model that represents a reaction of an investor to changes in the market that deviate from the predetermined investment strategy. For example, the behavior model can define a predetermined percentage drawdown of the portfolio value and enforce a sell-off part of the portfolio when the value of the portfolio is below the predetermined percentage drawdown for a predetermined number of days.

Instead of simply simulating a known portfolio, the portfolio evaluator 26 can determine an optimal portfolio, based on a plurality of generated synthetic time series. In one example, an investor defines a desired return, a goal horizon, and a minimum acceptable probability of success in achieving the desired return within the goal horizon, and the portfolio evaluator 26 determines appropriate constraints for an optimization process based on these values and the plurality of synthetic time series. The optimization process can then be performed to determine an optimal portfolio for the investor.

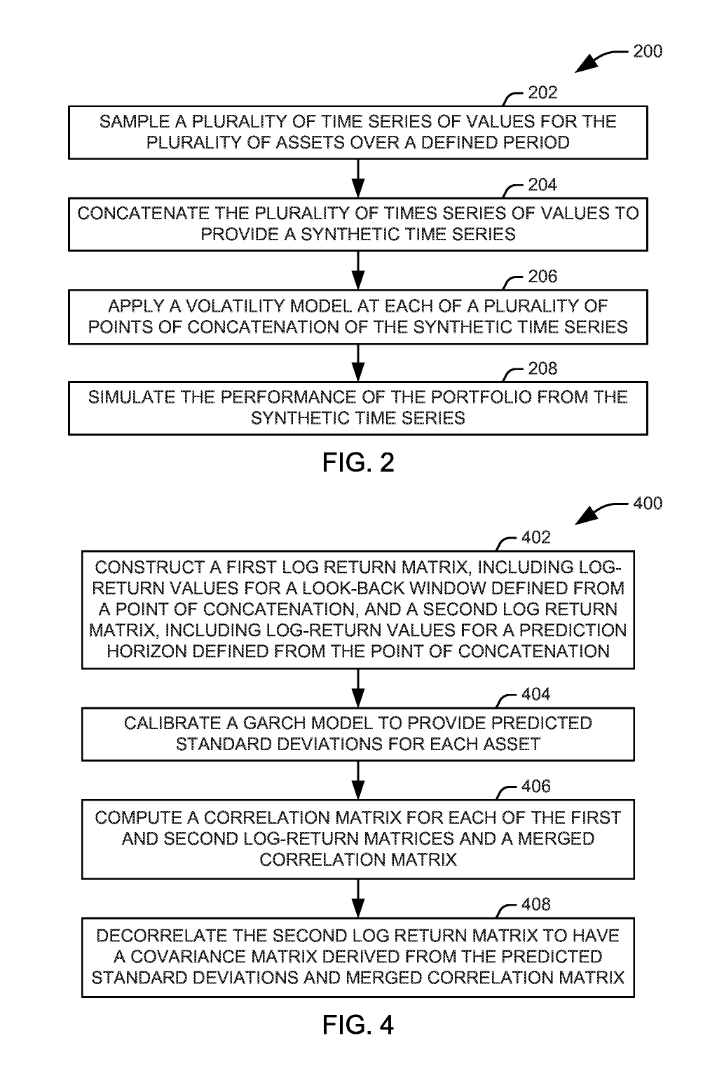

In view of the foregoing structural and functional features described above, example methods will be better appreciated with reference to FIGS. 2-8. While, for purposes of simplicity of explanation, the example methods of FIGS. 2-8 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement a method.

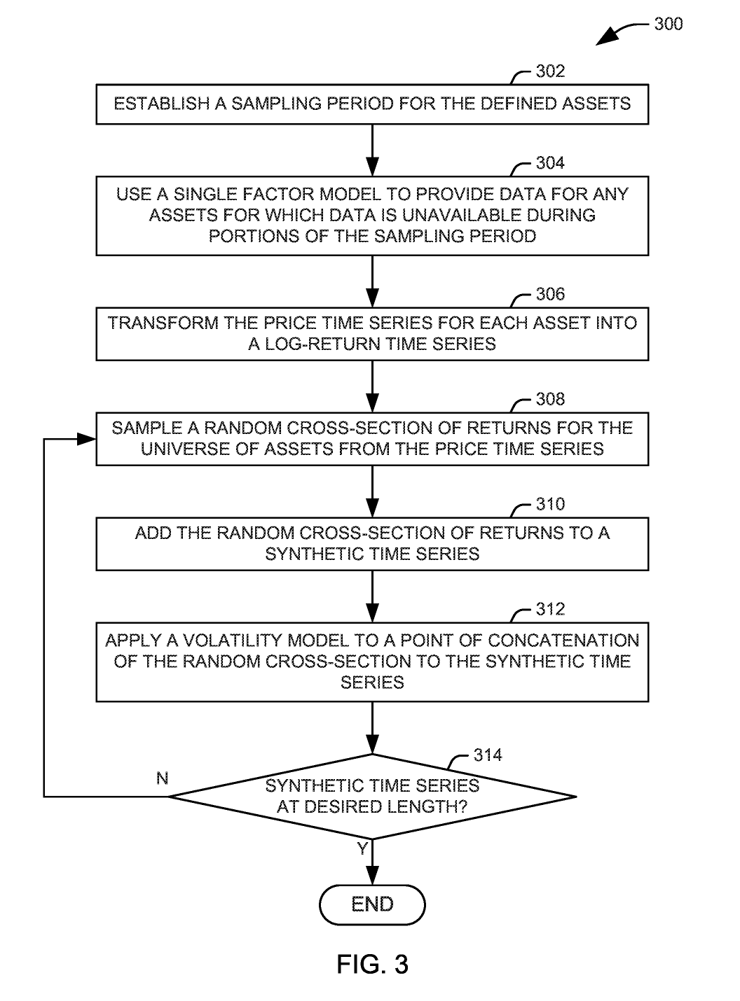

FIG. 2 illustrates one example of a method 200 for projecting the performance of a portfolio drawn from an available plurality of assets. At 202, a plurality of time series of values fare sampled for the plurality of assets over a defined period. At 204, the plurality of times series of values are concatenated, at a corresponding plurality of points of concatenation, to provide a synthetic time series. One example of method blocks 202 and 204 can be seen in FIG. 3, which illustrates one example of a method 300 for generating a synthetic time series of prices for a defined universe of assets. At 302, a sampling period is established for the defined assets. The sampling period can be selected to be as large as possible, given the availability for price information for the assets, up to a threshold value, such as fifty years. Daily prices for these assets are collected over this period.

It will be appreciated that individual securities in the universe may have gaps in their history, either from trading stops or due to the relative youth of the security. For example, a company such as Facebook has only traded for a few years, while it may be desirable to sample prices at least a decade into the past. At 304, a single factor model, wherein an underlying factor is assigned to the asset, preferably by definition, is used to provide data for any assets for which data is unavailable during portions of the sampling period. For example, if the underlying security is a large British telecom, then the underlying factor is the EAFE (large capitalization developed market equity) asset class, and the price of the asset can be modeled from an average behavior of this asset class and the available price information for the asset. If the security cannot be classified in this manner, then a linear regression is calculated on the returns of the asset against the returns of each factor security, and the resulting model is used to fill in any missing prices. At 306, the price time series for each asset is then transformed in the log-return time series, sₜ=ln(rₜ/rₜ−1).

At 308, a random cross-section of returns for the universe of assets are sampled from the corresponding price time series. In one example, the random cross-section has a randomly selected starting point, tₐ, selected from a uniform distribution, and a randomly selected length, b, selected from a lognormal distribution, such that, the random cross-section includes the prices for all assets on the interval [tₐ, t_{a+b}]. At 310, the selected random cross-section is added to a synthetic time series. If the selected random cross-section is the first selected time series, it forms a beginning of the synthetic time series. Otherwise, the selected random cross-section is concatenated onto the existing synthetic time series.

Since the synthetic time series rearranges the temporal order of the original historical time series, any inter-temporal relationships are likely damaged or destroyed, notably at the points of concatenation between selected cross-sections. Without this memory in the series the phenomenon known as volatility clustering is lost. To correct for this, at 312 a volatility model is applied at the point of concatenation, if any, between the selected random cross-section and the existing synthetic time series, such that values within the selected random cross-section are altered in response to the applied volatility model. It will be appreciated that the volatility model will not be necessary for the initial iteration through 308, 310, and 312, as no point of concatenation will be present. At 314, it is determined if the synthetic time series has reached a desired length. If not (N), the method returns to 308 to select a new cross-section of returns. If so (Y), the method terminates.

Returning to FIG. 2, at 206, a volatility model is applied at each of the plurality of points of concatenation, such that a first set of values of the synthetic time series that follow the point of concatenation are altered at least in part according to a correlation matrix generated from a second set of values of the synthetic time series that precede the point of concatenation. FIG. 4 illustrates one example of a method 400 for applying a volatility model to a point of concatenation between two time series. At 402, two log-return matrices are constructed, including F_{before}, which is an S×L matrix and F_{after}, which is an S×N matrix, where S is the number of assets in the defined universe of assets, L is a predefined length of a look-back window for the volatility model, and N is a predefined prediction horizon for the volatility model. Accordingly, the F_{before} matrix represents L samples preceding the point of concatenation, and the F_{after} represents the N points following the point of concatenation.

At 404, a generalized autoregressive conditional heteroskedasticity (GARCH) model is calibrated for each asset, s, using data up to and including the point of concatenation. An autoregressive conditional heteroskedasticity (ARCH) model is a statistical model for time series data that describes the variance of the current error term as a function of the actual sizes of the previous time periods' error terms. In a GARCH model, an autoregressive moving average (ARMA) model is assumed for the variance of the error term. The GARCH model is used to forecast volatility into the time series as a set of time dependent standard deviations, \hat{σ}ₛ. In one example, a Glosten-Jagannathan-Runkle (GJR) GARCH is used that also models asymmetry in the ARCH process.

At 406, three correlation matrices are computed from the log-return matrices, F_{before} and F_{after}. C_{before} is a correlation matrix representing F_{before}, C_{after} is a correlation matrix representing F_{after}, and C_{merged} is calculated as wC_{before}+(1−w)C_{after}, where w is a parameter, ranging between zero and one, that specifies the memory of the correlation matrix, C_{merged}. At 408, F_{after} is decorrelated, or “whitened”, and altered to have a covariance matrix based on the time dependent standard deviation forecast at 404 and the merged correlation matrix, C_{merged}. To this end, a merged covariance matrix, Σ_{merged}, is generated, in which each element, σᵢⱼ, is the product of the projected time dependent standard deviations for the corresponding securities, \hat{σ}ᵢ and \hat{σ}ⱼ, and the corresponding element, cᵢⱼ, from the merged correlation matrix, C_{merged}. A new log-return matrix, F_{merged}, to replace the log-return matrix F_{after} is calculated as:

F_{merged}=(F_{before}−μ)M\hat{M}+μ Eq. 1

where μ is a matrix formed via L concatenated copies of a vector of the row means of F_{after} to form an S×L matrix, M is the unique inverse matrix square root of the covariance matrix of F_{before}, and \hat{M} is the square root of the merged covariance matrix, Σ_{merged}.

It will be appreciated that the generation of the synthetic price series, as described in FIGS. 3 and 4, is governed by a number of metaparameters that can be specific to a given universe of assets. These metaparameters include the mean and standard deviation of the lognormal distribution used at 308 to select the length of each new time series, the length of the look back window, L, the length of the prediction horizon, N, and the parameter, w, specifying the memory of the merged correlation matrix. These parameters can themselves be selected via a parallelized optimization technique, such as an evolutionary algorithm search, to minimize a difference between the volatility-clustering factor for the synthetic data series and the historical volatility-clustering factor for the universe of assets. For a given universe of assets containing a set, S, of R securities, the volatility-clustering factor, V, can be calculated as:

$$V = \frac{1}{R} {\sum }_{s ϵ S} \frac{{σ}_{actual}}{{σ}_{predicted}} \qquad Eq . 2$$

where σ_{actual} is the standard deviation of the number of days that empirical returns exceed a q % quantile on a rolling look-back of D days and σ_{predicted} is the standard deviation of the number of days that exceed the q % quantile under the assumption of normally distributed returns.

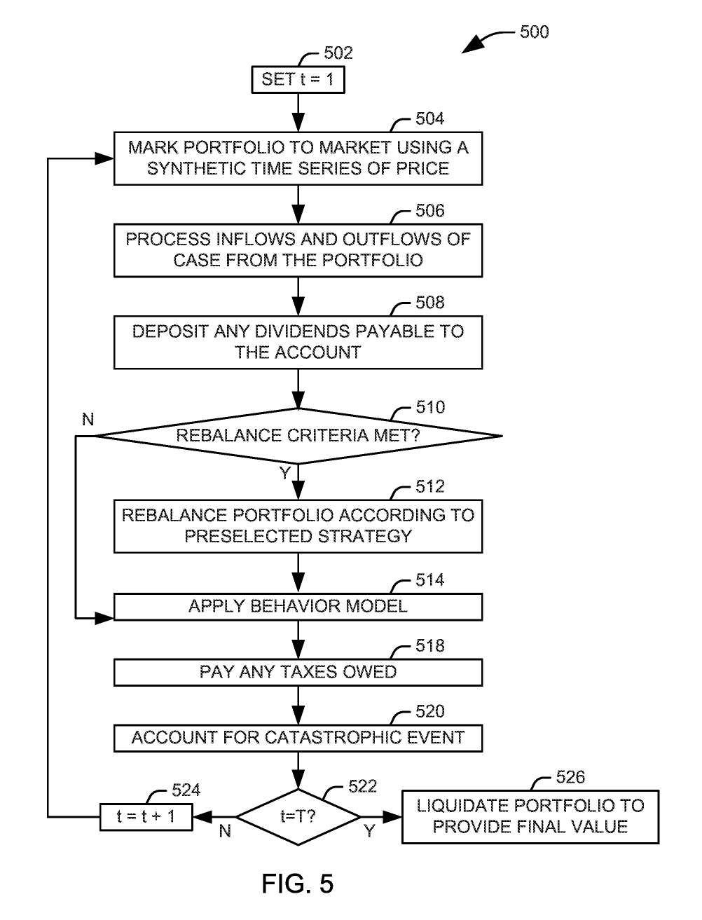

Returning to FIG. 2, at 208, the performance of the portfolio is simulated from the synthetic time series to provide a projected value of the portfolio at a selected goal horizon. FIG. 5 illustrates a method 500 for evaluating a portfolio over a selected forecast period, containing T days, with a synthetic price history, such as that generated in FIG. 3. At 502, an initial day, t=1, is selected for the selected forecast period. At 504, the portfolio is marked to market using the generated prices for that date and the daily return is calculated. At 506, any inflows or outflows of securities or cash from the portfolio are processed.

At 508, any dividends that might be payable to the account are deposited as cash in the account, with appropriate deductions for estimated taxes. This will generally occur as yearly dividends on the first day of each simulated year. Since the amount of a dividend paid by a security is not known a priori, future dividends can only be estimated. And likewise, since the percentage of these dividends that are qualified vs. non-qualified are not known a priori, this percentage also must be estimated. It is fortunate that, at least in the short term, these estimates are relatively accurate. The dividend of a security is calculated as the average annualized yield on a trailing look-back window, excluding any payment more a threshold number of standard deviations from the mean, as these are often one-time only dividends and are not expected to continue into the future. The percentage of dividends classified as “qualified” is based on the last known reported value for the individual security, and where this data is not available it is calculated as the average value within the security's asset class of known values.

At 510, it is determined if strategy-specific rebalance criteria are met. If the criteria are met (Y), the portfolio is rebalanced according to the selected strategy at 512. The method then continues to 514. If not (N), the method simply continues to 514. It will be appreciated that the rebalance criteria is strategy specific and can include a simple yearly or quarterly rebalancing or be triggered by deviation from a target allocation beyond a certain threshold. In one example, the rebalancing strategy determines, for each risk factor in the portfolio, the current dollar (or risk-dollar) exposure. If it differs from the overall portfolio target dollar (or risk-dollar) exposure, a rebalancing or re-optimization of the portfolio is triggered.

At 514, a behavior model, representing an investor's reaction to changes in the market, is applied to the portfolio. At 518, any taxes owed from either dividend payments or security liquidations are paid out from the portfolio. If there is not enough cash in the portfolio to pay the taxes owed then the cash is raised from the sale of securities, pro rata, from all accounts which allow withdrawals. At 520, the chance of a catastrophic event, such as a major hospital bill, is calculated, for example, via a Poisson process, and deducted from the portfolio. At 522, it is determined if it is the last day for the simulation, such that t=T. If not (N), the day counter, t, is advanced at 524, and the method returns to 504. If it is the final day, all positions are liquidated, and any taxes are deducted from the cash position, pro rata across accounts, at 526 to provide a final value for the portfolio.

It will be appreciated that a given portfolio can be simulated multiple times to provide a set of metrics for the portfolio. For each simulation, i, a time-series of portfolio returns is calculated at each time t, {pₜ,i}. An average case is computed as the median return at each time t, along with high and low quantiles at a selected percentile, q %. Performance metrics such as average total return, volatility, and sharpe are then calculated on these summary statistics, and these metrics can be considered the expected performance of the strategy and can be compared across simulations. Additionally, summary statistics are calculated on the probability that certain financial goals are or are not met along each path.

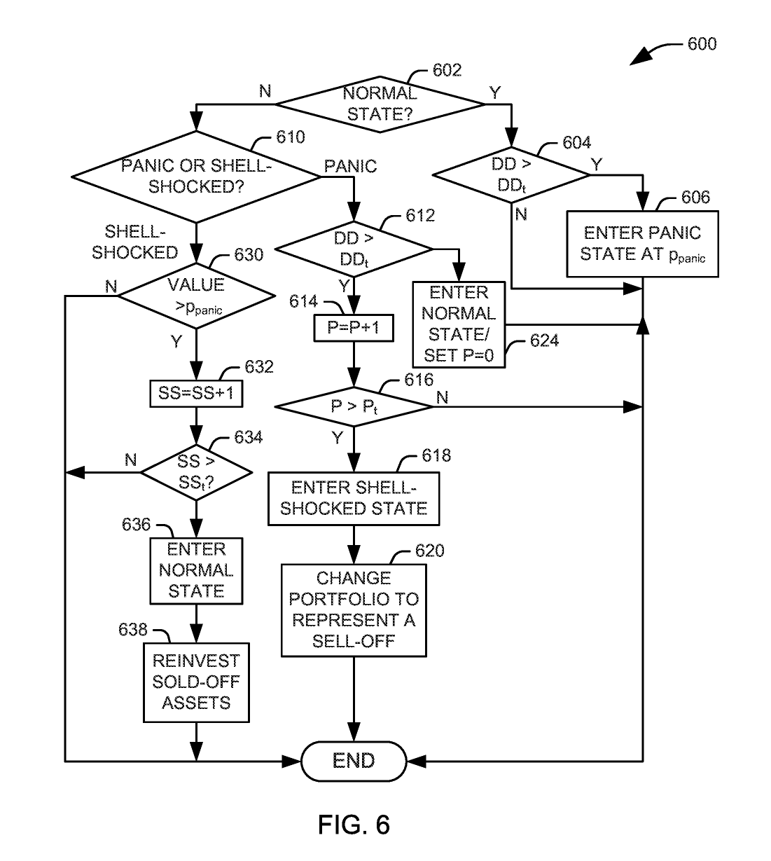

FIG. 6 illustrates one example of a method 600 for modeling investor behavior that can be used at block 516 of FIG. 5. It will be appreciated that the values for counters and the state of the investor is saved across iterations through the method of FIG. 5, such that one pass through the method 600 represents one day in the portfolio simulation of FIG. 5. At 602, it is determined if the investor is in a default state, referred to as “normal.” If so (Y), the method advances to 604, where it is determined if the portfolio is in a drawdown, DD, that is below a threshold, DDₜ specified a priori by the investor. For the purposes of this example, a drawdown is defined as:

$$DD = \frac{{p}_{h} - {p}_{c}}{{p}_{h}} \qquad Eq . 3$$

where pₕ is a historical maximum value of the portfolio and p_{c} is a current value of the portfolio.

If the portfolio is not in a drawdown that falls below the threshold value (N), the method terminates, and the investor remains in the “normal state.” If the portfolio is in a drawdown that falls below the threshold value (Y), the investor enters a panic state at 606, with the dollar value of the portfolio when the investor entered the panic state saved as P_{panic}. The method then terminates.

Returning to 602, if the investor is not in the normal state, the method advances to 610, where it is determined if the investor is in the panic state or a shell-shocked state, which will be explained below. If the investor is in the panic state (PANIC), the method advances to 612, where it is determined if the portfolio is in a drawdown that is below the threshold. If so (Y), a panic counter, P, increments at 614. At 616, it is determined if the panic counter exceeds a predetermined threshold, Pₜ. If not (N), the method terminates, and the investor remains in the panic state. If the panic counter exceeds the threshold value (Y), the investor enters the shell-shocked state at 618. At 620, the simulated portfolio is changed to represent a sell-off of a predetermined percentage of assets in response to the drawdown. The sale is simulated as a pro-rata sell off across all assets except for fixed positions that are defined by the investor. The method then terminates.

Returning to 612, if the portfolio is not in a drawdown that is below the threshold (N), the panic counter, P, resets, and the investor returns to the normal state at 624. Returning to 610, if the investor is in the shell-shocked state (SHELL-SHOCKED), it is determined at 630 if the value of the portfolio has risen above the value at which the investor entered the panic state, p_{panic}. If not (N), the method terminates with the investor remaining in the shell-shocked state. If so (Y), the method advances to 632, where a counter, SS, is incremented. At 634, it is determined if the shell-shocked counter meets a predetermined threshold value, SSₜ. If not (N), the method terminates with the investor remaining in the shell-shocked state. If the shell-shocked counter does meet the threshold value (Y), the shell-shocked counter, SS, resets, and the investor returns to the normal state at 636. The cash held from the sale upon entering the shell-shocked state is reinvested at 638. For example, the funds can be reallocated into assets according to a last target portfolio. The method then terminates.

The most straightforward application of the simulation process is projecting future performance for a specific portfolio or group of portfolios. Given a portfolio, future cashflows can be projected to allow an investor to plan for future liabilities, such as a retirement drawdown or college tuition. The process can capture path dependencies in the cashflows and allow the direct measurement of the probabilities of success in attaining future financial goals. Given two portfolios or a marginal adjustment to a portfolio, the simulation allows for the direct comparison of performance which would allow one to judge the desirability of one portfolio over another or a change to a current portfolio.

Aside from simply reporting and measuring expected portfolio performance, the simulation method can be incorporated into an optimization process to construct portfolios targeted at particular benchmarks or in service of a particular set of well-defined goals. For example, a set of goals can be defined as the tuple (Θ, ψ, Π) where θ is the required dollars for the goal, inflation adjusted if desired, ψ is the goal horizon or time until the money for the goal is needed, usually in units of years, and II is the desired minimum probability of success. For example, a goal may be, “I want $100,000 in a college account with 75% surety within 8 years.”

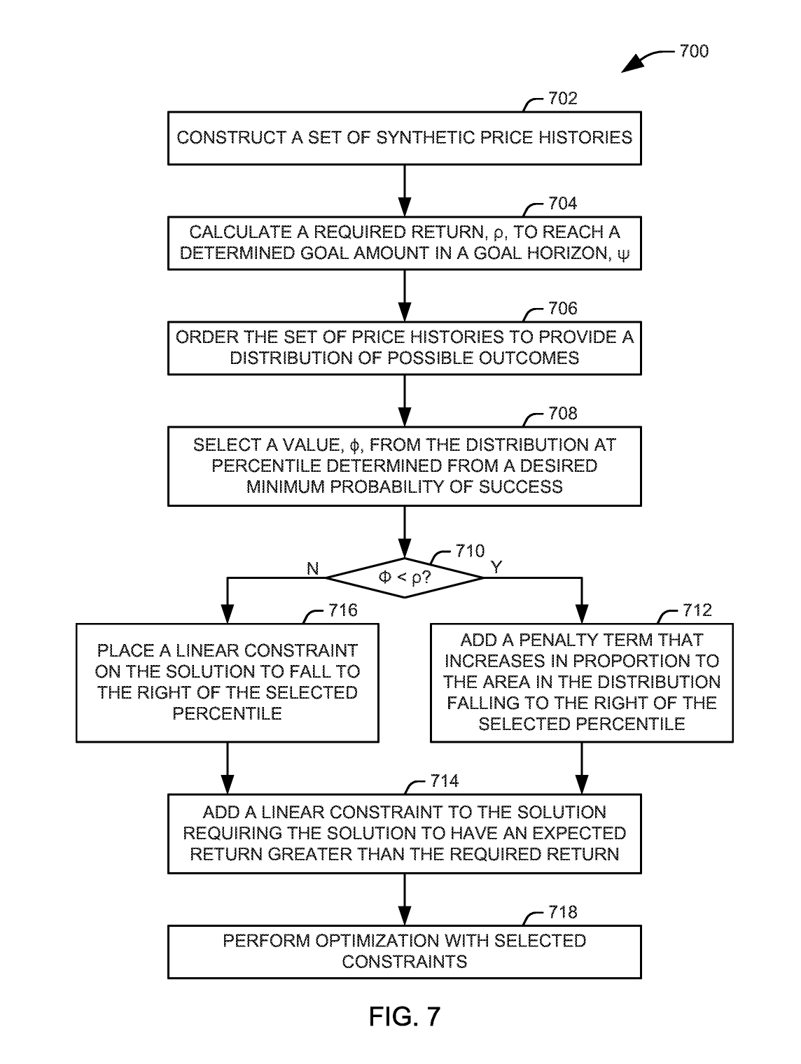

FIG. 7 illustrates one example of a method 700 for determining an optimal portfolio. Specifically, for a given portfolio optimization and set of goals, the method 700 constructs a constraint on the optimization process for each individual goal. At 702, a set of N synthetic price histories are constructed, incorporating any existing or potential securities considered for the investment portfolio over a defined goal horizon, ψ. It will be appreciated that FIGS. 3 and 4 provide an example for generating the synthetic price histories. At 704, the required return, ρ, necessary to grow the current principal in the portfolio to a determined goal amount over the goal horizon is calculated.

At 706, the set of N price histories are ordered by their final simulated returns, to provide a distribution of possible outcomes. At 708, a value is selected representing a desired percentile, equal to (1−Π), where II is a desired minimum probability of success. At 710, it is determined if the return, ϕ, at this point is less than ρ. If so (Y), It is not expected that the defined goal can be hit with the required expectation. The method proceeds to 712, where a penalty term is added to the objective function that increases in proportion to the area in the distribution falling to the right of the selected percentile. In one implementation, the penalty is equal to −ΣAx, where A is a (n×m) matrix of returns at the goal horizon for n paths over m securities, and x is a proposed solution. The penalty attempts to minimize the expected shortfall at the horizon. The method advances to 714.

If the return, ϕ, is not less than ρ (N), the method advances to 716, where a linear constraint is placed on the solution, x, to lie on the distribution to the right of the desired percentile. The method then advances to 714, where a linear constraint is added to the optimization problem requiring the solution to have an expected return greater than ρ expressed on an annualized basis. The optimization is then performed at 718, subject to the constraints placed at 712, 714, and 716.

The method of FIG. 7 can be iterated any number of times, further specifying additional goals. The operation is flexible enough to work within both a Mean-Variance framework or a more generalized optimization framework, such as a risk-parity formulation. This provides a quantitative framework for constructing portfolios specifically tailored around an investor's goals.

FIG. 8 is a schematic block diagram illustrating an exemplary system 800 of hardware components capable of implementing examples of the systems and methods disclosed in FIGS. 1-7, such as the portfolio modeling system illustrated in FIG. 1. The system 800 can include various systems and subsystems. The system 800 can be a personal computer, a laptop computer, a workstation, a computer system, an appliance, an application-specific integrated circuit (ASIC), a server, a server blade center, a server farm, etc.

The system 800 can includes a system bus 802, a processing unit 804, a system memory 806, memory devices 808 and 810, a communication interface 812 (e.g., a network interface), a communication link 814, a display 816 (e.g., a video screen), and an input device 818 (e.g., a keyboard and/or a mouse). The system bus 802 can be in communication with the processing unit 804 and the system memory 806. The additional memory devices 808 and 810, such as a hard disk drive, server, stand-alone database, or other non-volatile memory, can also be in communication with the system bus 802. The system bus 802 interconnects the processing unit 804, the memory devices 806-810, the communication interface 812, the display 816, and the input device 818. In some examples, the system bus 802 also interconnects an additional port (not shown), such as a universal serial bus (USB) port.

The processing unit 804 can be a computing device and can include an application-specific integrated circuit (ASIC). The processing unit 804 executes a set of instructions to implement the operations of examples disclosed herein. The processing unit can include a processing core.

The additional memory devices 806, 808 and 810 can store data, programs, instructions, database queries in text or compiled form, and any other information that can be needed to operate a computer. The memories 806, 808 and 810 can be implemented as computer-readable media (integrated or removable) such as a memory card, disk drive, compact disk (CD), or server accessible over a network. In certain examples, the memories 806, 808 and 810 can comprise text, images, video, and/or audio, portions of which can be available in formats comprehensible to human beings. Additionally or alternatively, the system 800 can access an external data source or query source through the communication interface 812, which can communicate with the system bus 802 and the communication link 814.

In operation, the system 800 can be used to implement one or more parts of a diagnostic and decision support system in accordance with the present invention. Computer executable logic for implementing the composite applications testing system resides on one or more of the system memory 806, and the memory devices 808, 810 in accordance with certain examples. The processing unit 804 executes one or more computer executable instructions originating from the system memory 806 and the memory devices 808 and 810. The term “computer readable medium” as used herein refers to any medium that participates in providing instructions to the processing unit 804 for execution, and it will be appreciated that a computer readable medium can include multiple computer readable media each operatively connected to the processing unit.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A method for projecting the performance of a portfolio drawn from an available plurality of assets comprising:
sampling a plurality of time series of values for the plurality of assets over a defined period;
concatenating the plurality of times series of values, at a corresponding plurality of points of concatenation, to provide a synthetic time series;
applying a volatility model at each of the plurality of points of concatenation, such that a first set of values of the synthetic time series that follow the point of concatenation are altered at least in part according to a correlation matrix generated from a second set of values of the synthetic time series that precede the point of concatenation; and
simulating the performance of the portfolio from the synthetic time series to provide a projected value of the portfolio at a selected goal horizon.

2. The method of claim 1, wherein sampling the plurality of time series for the plurality of assets over the defined period comprises randomly selecting each of a starting point and a length for each time series.

3. The method of claim 2, wherein randomly selecting the starting point for each time series comprises selecting a value from a uniform distribution and randomly selecting the length for each time series comprises selecting the length from a lognormal distribution.

4. The method of claim 1, wherein the correlation matrix is a first correlation matrix and applying the volatility model at each of the plurality of points of concatenation comprises:
generating a second correlation matrix from the first set of values;
generating a third correlation matrix as a weighted linear combination of the first correlation matrix and the second correlation matrix;
generating a covariance matrix from at least the third correlation matrix; and
altering the first set of values from the generated covariance matrix.

5. The method of claim 4, further comprising applying an autoregressive conditional heteroskedasticity model to a set of data for each of the plurality of assets that includes the second set of values and does not include the first set of values to provide an projected standard deviation for each of the plurality of assets, generating the covariance matrix comprises determined each element of the covariance matrix as the product of the projected standard deviation of the asset associated with the column of the element, the projected standard deviation of the asset associated with the row of the element, and the corresponding element from the third correlation matrix.

6. The method of claim 5, wherein the autoregressive conditional heteroskedasticity model is a Glosten-Jagannathan-Runkle generalized autoregressive conditional heteroskedasticity model.

7. The method of claim 5, wherein the covariance matrix is a first covariance matrix and first set of values are altered to a value that is a function of each of a set of mean values for each asset across the second set of values, the second set of values, a square root of the first covariance matrix, and a unique inverse matrix square root of a second covariance matrix representing the second set of values.

8. The method of claim 4, wherein each of the number of values in the first set of values, the number of values in the second set of values, and at least one weight for the weighted linear combination are determined via an optimization process that minimizes a difference between a volatility-clustering factor for the synthetic data series and a historical volatility-clustering factor for the plurality of assets.

9. The method of claim 1, simulating the performance of the portfolio from the synthetic time series comprises evaluating the portfolio over a predetermined number of days and rebalancing the portfolio according to a predetermined investment strategy when a predetermined condition is met.

10. The method of claim 9, wherein simulating the performance of the portfolio from the synthetic time series further comprises applying a behavior model, representing a reaction of an investor to changes in the market that deviate from the predetermined investment strategy.

11. The method of claim 10, wherein the behavior model includes a predetermined percentage drawdown of the portfolio value, and simulating the performance of the portfolio includes selling off part of the portfolio when the value of the portfolio is below the predetermined percentage drawdown for a predetermined number of days.

12. The method of claim 1, wherein simulating the performance of the portfolio from the synthetic time series comprises simulating the performance of a plurality of portfolios from a corresponding plurality of synthetic time series, the method further comprising determining an optimal portfolio given the synthetic price series, a desired return, a goal horizon, and a minimum acceptable probability of success in achieving the desired return within the goal horizon.

13. A system comprising:
a processor; and
a non-transitory computer readable medium storing instructions executable by the processor for projecting the performance of a portfolio drawn from an available plurality of assets, the executable instructions comprising:
a database comprising values for the plurality of assets over a defined period;
a time series generator that samples a plurality of time series of values for the plurality of assets from the database and concatenates the plurality of times series of values, at a corresponding plurality of points of concatenation, to provide a synthetic time series; and
a portfolio evaluator that simulates the performance of the portfolio from the synthetic time series to provide a projected value of the portfolio at a selected goal horizon by evaluating the portfolio over a predetermined number of days, rebalancing the portfolio according to a predetermined investment strategy when a predetermined condition is met, and applies a behavior model to the portfolio, representing a reaction of an investor to changes in the market that deviate from the predetermined investment strategy.

14. The system of claim 13, wherein the behavior model includes a predetermined percentage drawdown of the portfolio value, and simulating the performance of the portfolio includes selling off part of the portfolio when the value of the portfolio is below the predetermined percentage drawdown for a predetermined number of days.

15. The system of claim 13, wherein the time series generator applies a volatility model at each of the plurality of points of concatenation, such that a first set of values of the synthetic time series that follow the point of concatenation are altered at least in part according to a correlation matrix generated from a second set of values of the synthetic time series that precede the point of concatenation.

16. The system of claim 13, wherein the portfolio evaluator simulates the performance of a plurality of portfolios from a corresponding plurality of synthetic time series and determines an optimal portfolio given the synthetic price series, a desired return, the goal horizon, and a minimum acceptable probability of success in achieving the desired return within the goal horizon.

17. A method for projecting the performance of a portfolio drawn from an available plurality of assets comprising:
sampling a plurality of time series of values for the plurality of assets over a defined period;
concatenating the plurality of times series of values, at a corresponding plurality of points of concatenation, to provide a synthetic time series;
applying a volatility model at each of the plurality of points of concatenation, such that a first set of values of the synthetic time series that follow the point of concatenation are altered at least in part according to a correlation matrix generated from a second set of values of the synthetic time series that precede the point of concatenation; and
simulating the performance of the portfolio from the synthetic time series to provide a projected value of the portfolio at a selected goal horizon by evaluating the portfolio over a predetermined number of days, rebalancing the portfolio according to a predetermined investment strategy when a predetermined condition is met, and applying a behavior model to the portfolio, representing a reaction of an investor to changes in the market that deviate from the predetermined investment strategy.

18. The method of 17, wherein sampling the plurality of time series for the plurality of assets over the defined period comprises randomly selecting a starting point for each time series from a uniform distribution and randomly selecting a length for each time series comprises selecting the length from a lognormal distribution having an associated mean and standard deviation.

19. The method of claim 18, wherein the correlation matrix is a first correlation matrix and applying the volatility model at each of the plurality of points of concatenation comprises:
generating a second correlation matrix from the first set of values;
generating a third correlation matrix as a weighted linear combination of the first correlation matrix and the second correlation matrix;
generating a covariance matrix from at least the third correlation matrix; and
altering the first set of values from the generated covariance matrix.

20. The method of claim 19, wherein each of the number of values in the first set of values, the number of values in the second set of values, the standard deviation of the lognormal distribution, the mean of the lognormal distribution, and at least one weight for the weighted linear combination are determined via an optimization process that minimizes a difference between a volatility-clustering factor for the synthetic data series and a historical volatility-clustering factor for the plurality of assets.
